(19) United States
(12) Patent Application Publication
(10) Pub. No.: US 2026/0088850 A1
(43) Pub. Date: Mar. 26, 2026

(54) PRINTED, FLEXIBLE, AND CONFORMAL BLUETOOTH LOW ENERGY SYSTEM AND METHODS

(71) Applicant: KING ABDULLAH UNIVERSITY OF SCIENCE AND TECHNOLOGY, Thuwal (SA)

(72) Inventors: Zubair AKHTER, Thuwal (SA); Rana Muhammad BILAL, Thuwal (SA); Firas FATANI, Thuwal (SA); Atif SHAMIM, Thuwal (SA); Mohammad VASEEM, Thuwal (SA)

(21) Appl. No.: 19/109,444

(22) PCT Filed: Sep. 13, 2023
(86) PCT No.: PCT/IB2023/059090

§ 371 Date: Mar. 6, 2025

Related U.S. Application Data
(60) Provisional application No. 63/406,372, filed on Sep. 14, 2022.
(60) Provisional application No. 63/439,897, filed on Jan. 19, 2023.

(51) Int. Cl. H04B 1/3827; H04W 4/80

(52) U.S. Cl. CPC H04B 1/385; H04W 4/80

(57) ABSTRACT

A Bluetooth low energy, BLE, communication system includes a BLE network including plural nodes for transmitting a signal in a hop-on manner; a BLE wearable configured to be attached to a person and to communicate with a first node of the plural nodes through a first BLE link, wherein the BLE wearable is printable, flexible, and disposable; and a BLE sticker configured to be attached to an object and to communicate with a second node of the plural nodes through a second BLE link, or with the first node. The BLE wearable includes a BLE module for directly communicating with the BLE network, and a near field communication, NFC, module for directly communicating with a point-of-sale device or access control unit. The BLE module is configured to order a product or a service through the BLE network and the NFC module is configured to pay for the ordered product or service at the point-of-sale device or to open or close an access door.

### CROSS-REFERENCE TO RELATED APPLICATIONS

This application claims priority to U.S. Provisional Patent Application No. 63/406,372, filed on Sep. 14, 2022, entitled “MODULATING MIT TEMPERATURE OF VO2 (M) NANOPARTICLES FOR HIGHLY SENSITIVE FULLY-PRINTED SKIN TEMPERATURE SENSOR,” and U.S. Provisional Patent Application No. 63/439,897, filed on Jan. 19, 2023, entitled “PRINTED, FLEXIBLE, AND CONFORMAL BLE WEARABLES AND STICKERS CAPABLE OF WORKING WITH BLUETOOTH MESH NETWORK,” the disclosures of which are incorporated herein by reference in their entirety.

### BACKGROUND OF THE INVENTION

### Technical Field

Embodiments of the subject matter disclosed herein generally relate to low energy wireless communication devices, systems, and methods employing a low energy wireless communication protocol for integrating plural location-based services, financial services, and/or medical services into a single system.

### Discussion of the Background

The continuing decrease of the size and the cost of low energy wireless communication chips has expanded the applications of these chips beyond conventional communication devices to many devices that had never before been connected to a network. This has spawned the term Internet of Things (IoT) to describe the connection of various disparate types of devices beyond conventional communication devices. One of the most popular and widely-used IoT enabling technology is Bluetooth Low Energy (BLE).

Due to the availability of the BLE technology, and having the right BLE based devices in place, it is now possible to build a smart city, a smart beach, a smart mall, a smart resort, or a smart event (essentially, a smart community). The convergence of technology and urban living has given rise to the concept of the smart community, where innovation is seamlessly integrated into the daily lives of its inhabitants. At the heart of this evolution lies the utilization of BLE wearable devices and/or BLE stickers, which have transcended their initial roles, to revolutionize how people order, pay for, and enjoy any location-based service, for example, food, services, emergency services, medical services, etc.

The planners of the smart communities would need to provide their inhabitants with convenience at their fingertips, thanks to wearable devices and/or asset stickers that are not just fashionable accessories, but also powerful tools for simplifying tasks. The dream of such planners is to make possible that a person, engrossed in a task, simply raises their wrist to access their wearable device. With a simple gesture, an interface materializes on the wearable, showcasing a curated selection of nearby eateries and their offerings. Utilizing advanced location tracking, preference analysis, and historical data, the device suggests personalized options tailored to individual tastes and dietary restrictions. A mere touch of an area of the wearable translates into a quick food order.

Still part of this dream, is a seamless payment integration. The planners need to ensure that gone are the days, for the person ordering the food, of looking for wallets or smartphones. The wearable device has been transformed into a secure digital wallet, seamlessly integrated with banking systems and payment gateways. Upon confirming the food order, the wearer's device communicates with the eatery's point-of-sale system through the BLE mesh network. A secure authentication process ensues, leveraging biometric data or PIN codes or other technologies to ensure authorized access. Once authenticated, the payment is processed immediately, with the transaction details relayed back to both the wearable and the eatery's systems. In this smart community, the goal is to not have to scan QR codes, input card details, or sign receipts.

Central to this desired smart community is the BLE mesh network, a web of interconnected devices facilitating seamless communication. In a densely populated smart city, a conventional point-to-point communication model could strain network resources. The BLE mesh network solves this challenge by allowing data to hop from device to device, forming a dynamic and robust network architecture. As wearable devices communicate with each other and with various points of interaction, such as restaurants and payment gateways in this example, data travels swiftly and securely across the community's fabric. The mesh network's low energy consumption ensures prolonged device battery life, contributing to sustainability efforts.

The restaurants in this example may use the BLE stickers to monitor their inventory, how much food is available, and especially how much of each component of their dish is in stock. The brain of the restaurant, a computer, may be configured to automatically collect information from each sticker in the restaurant, estimate which food component is low, and automatically order from one or more vendors, through the BLE network, those food components so that the restaurant does not run out of that produce. The activity of the restaurant is then streamlined. The integration of wearable devices at the clients and tracking stickers at the food manufacturers in the smart community creates a profound shift in the human experience. Time once spent waiting in lines or dealing with transactional formalities or analyzing the inventory, or ordering supplies is now channeled into other activities. This example may be extended to most of the needs and activities present in the smart community.

However, the existing BLE devices and network configurations are not yet capable for providing the experiences discussed above. In this regard, [1] discloses a BLE network that is capable of providing targeted advertisements to a user based on his or her location in a shop. A fixed beacon in the specific shop interacts with a mobile phone of the user for achieving this result. Various companies have developed their own proprietary devices using BLE. For example, anchor beacon nodes [2] provided by Kontakt IO are simple BLE devices for installation in buildings or outdoor areas. However, these anchor beacon nodes can only operate with a smart phone as they do not have node to node communication capabilities. The function provided by this anchor beacon nodes is limited to broadcasting a unique ID at periodic intervals, which can be received by a smartphone.

BLE Beacons provided by Minew [3] function in a similar manner as Kontakt IO's Anchor beacons, i.e., they do not provide node-to-node communication and function by periodically broadcasting a unique ID. Thus, they neither support smart/IoT applications based on low cost, ultra-small BLE only devices nor are capable of real-time remote network management. Some BLE tags are available in the market, such as TrackR [4], Tile [5], and Apple AirTag [6] to provide asset monitoring. These tags are rigid (so cannot be easily placed on non-conformal objects) and they require the presence of a smartphone in close proximity to function. The Apple Watch [7] and Samsung Watch [8] do integrate BLE and near-field communication (NFC), but both are expensive, rigid devices. In addition to the cost disadvantage, the smartwatches are optimized for a very different purpose/market, i.e., personal use as an accessory of the user's smartphone rather than as an accessory of the BLE mesh network to provide IoT/smart services.

Thus, the existing BLE-based networks and devices are not appropriate for implementing the vision of a smart community as discussed above. Accordingly, there is a need for methods, devices, and systems that can use BLE wearable and/or stickers capable to order desired services, and pay for these services, while at the same time, they are inexpensive, flexible, and disposable.

### SUMMARY OF THE INVENTION

According to an embodiment, there is a Bluetooth low energy, BLE, communication system that includes a BLE network having plural nodes for transmitting a signal in a hop-on manner, a BLE wearable configured to be attached to a person and to communicate with a first node of the plural nodes through a first BLE link, wherein the BLE wearable is printable, flexible, and disposable, and a BLE sticker configured to be attached to an object and to communicate with a second node of the plural nodes through a second BLE link, or with the first node. The BLE wearable includes a BLE module for directly communicating with the BLE network, and a near field communication, NFC, module for directly communicating with a point-of-sale device or access control unit. The BLE module is configured to order a product or a service through the BLE network and the NFC module is configured to pay for the ordered product or service at the point-of-sale device or to open or close an access door.

According to another embodiment, there is a conformal wearable that includes a flexible battery configured to supply electrical power, a BLE module, a flexible microstrip patch antenna attached to a first side of the BLE module, and a temperature sensor attached to a second side of the BLE module, which is opposite to the first side. The temperature sensor includes a doped VO₂ sensing layer, the temperature sensor being configured to measure a temperature of a person wearing the wearable.

According to yet another embodiment, there is a temperature sensor that includes a substrate, first and second electrodes located on the substrate, and a W-doped VO₂ sensing layer located between and in electrical contact with ends of the first and second electrodes. The temperature sensor is configured to measure a temperature of a person wearing the wearable.

### BRIEF DESCRIPTION OF THE DRAWINGS

For a more complete understanding of the present invention, reference is now made to the following descriptions taken in conjunction with the accompanying drawings, in which:

FIG. 1 is a schematic diagram of a BLE system including a BLE network, a BLE wearable, and a BLE sticker;

FIG. 2 schematically illustrates the BLE network and its various components and how information travels along the network;

FIG. 3 schematically illustrates a BLE wearable and its communication capabilities with NFC and BLE enabled devices;

FIG. 4 schematically illustrates how the user of the BLE wearable interacts with the BLE network and a cloud server for ordering a product or a service and also for paying for it;

FIG. 5 illustrates a possible implementation of the BLE system in a resort environment;

FIGS. 6A to 6C illustrate a wearable that is configured to measure a temperature of the user;

FIG. 7A illustrates the monoclinic (M) phase of the vanadium dioxide while FIG. 7B illustrates the rutile (R) phase of the same material;

FIG. 8 is a flow chart of a method for making W-doped vanadium oxide nanoparticles;

FIG. 9 is a flow chart of a method for making an ink that includes the W-doped vanadium oxide nanoparticles;

FIGS. 10A and 10B illustrate the differential scanning calorimetry for undoped and doped vanadium oxide nanoparticles for various doping concentrations, and FIGS. 10C and 10D show the atomic concentration of the W in the sensing material including vanadium oxide nanoparticles;

FIG. 11 illustrates a method for manufacturing a temperature sensor that uses the doped vanadium oxide nanoparticles;

FIG. 12 illustrates the relative change in resistance of an un-doped, doped-without-encapsulation, and doped-with-encapsulation printed VO₂ sensor over the skin temperature range with 0.1° C. resolution;

FIG. 13 is a table that illustrates printed temperature sensors and their performance;

FIG. 14A illustrates the humidity effect on resistance, with and without encapsulation, of doped VO2 samples and FIG. 14B illustrates the temperature sensor's response on dry and wet skin;

FIG. 15 illustrates the bending effect on sensor's initial resistance under a ±45° bending angle over thousands of bending cycles;

FIG. 16 illustrates an implementation of the temperature sensor with an antenna, processor, memory, and battery for the wearable or sticker of the system of FIG. 1;

FIGS. 17A to 17C illustrate a microstrip patch antenna having symmetrical resonating slots near the patch non-resonating length, and a U-slot around a feeding port;

FIG. 18 illustrates the distribution of the temperature sensor, PCB readout circuit, battery and antenna for a specific wearable or sticker; and

FIGS. 19A and 19B illustrate the reflection coefficient (S₁₁) and the effect of the bending on the measured S₁₁ of the antenna of FIGS. 17A to 17C.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to a BLE system that includes a BLE mesh network, BLE wearable, and BLE sticker, for ordering a product and paying for the product with the BLE wearable, without the need for any credit card, cash, or smartphone. However, the embodiments to be discussed next are not limited to a system that can only order a product but may be applied to order and pay for any service, or just invoke a location-based service (for example, in medical facilities for collecting patient data), even if no payment is required.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification does not necessarily refer to the same embodiment. Further, the particular features, structures, or characteristics may be combined in any suitable manner in one or more embodiments.

According to an embodiment, a BLE system includes a BLE mesh network that uses hop-on communication, a BLE wearable that conforms to the hand of a user, and a BLE sticker that is fixedly attached to an object. The BLE wearable is configured to communicate with a node of the BLE mesh network through the BLE protocol and also to communicate, with a device that is not part of the BLE network, through the NFC protocol. Each of the BLE wearable and the BLE sticker is flexible (the entire module is flexible, not only a part of it) so that it conforms to any shape of the wearer (e.g., wrist), is inexpensive, printed, and disposable. In one application, the BLE wearable is configured to measure a parameter (e.g., the temperature) of the person wearing it, which is advantageous in medical facilities. Details about this system are now discussed according to various embodiments.

According to an embodiment, a BLE mesh network is configured to 1) bring smartness to a building (e.g., hotel, medical facility, shop, restaurant, resort, etc.) by enabling it to exchange information with custom low cost and ultra-small BLE wearables and stickers on people and assets, with no need to have smartphones present, and 2) enable real-time remote management/maintenance of the nodes in the network. The BLE wearable and BLE sticker discussed herein are unique as they can interface with the above defined BLE mesh network to enable many IoT applications. The BLE wearable and BLE sticker may include custom flexible antenna and customized printed circuit boards (PCBs) to enhance wearability and performance. Also, printed fabrication is used for the realization of such devices with a low cost. Because of the low cost, the wearable and the sticker are disposable or partially disposable if the PCT components are reused. The integration of the three elements noted above (i.e., BLE mesh, BLE wearable, and BLE sticker) results in the possibility of achieving the smart communities discussed in the Background section.

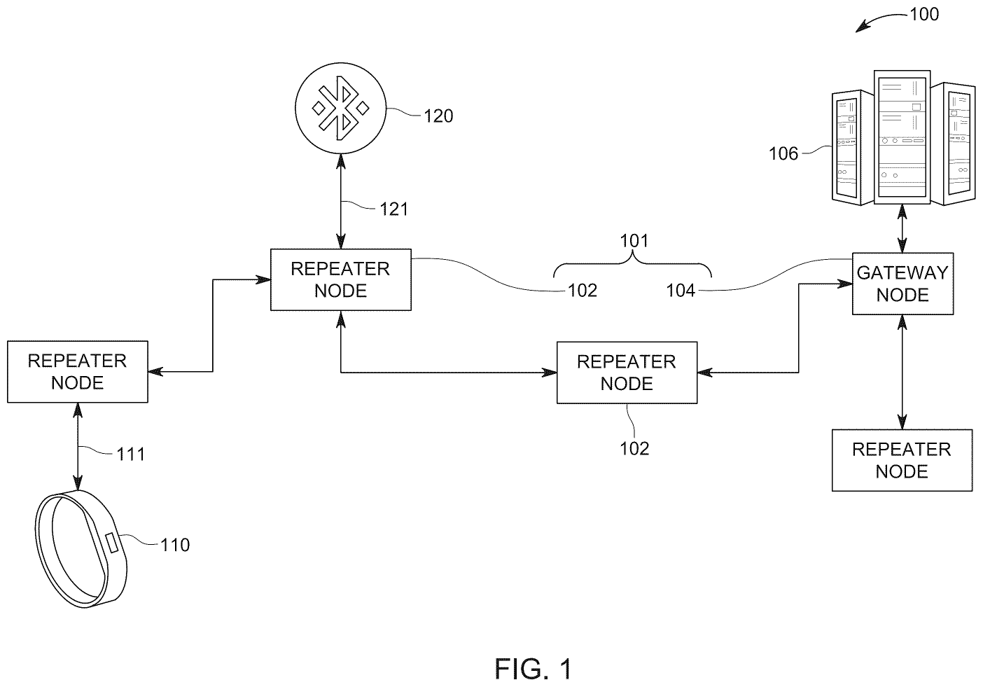

The BLE mesh network 101, which is schematically illustrated in FIG. 1 as being part of the system 100, includes low-cost BLE nodes 102, which are installed in buildings or even at outdoor locations, for example, bars, poles, bus stations, etc., and also at least one gateway node 104, for communicating with a server 106. The network 101 can communicate, through a first BLE link 111, with ultra-small, lightweight, and low-power BLE wearable 110, which is worn by a person, and through a second BLE link 121, with a BLE stickers 12, which is attached to an asset. Many wearables and stickers can be present in the network 101, however, for simplicity, FIG. 1 shows a single wearable and a single sticker. Unlike the existing systems, the network 101 was configured so that information can be transferred from one node 102 to the other 102 using multi-hopping (i.e., hopping information from one node to the next node 102 until it reaches the desired destination). These repeater nodes 102 communicate with at least one gateway node 104, as shown in the figure. The repeater node 102 is a BLE node that is responsible for communicating the data from the wearable and/or sticker to other nodes through multi-hopping. The gateway node 104, on the other hand, has internet connectivity to the server 106 using Ethernet or WiFi. The function of the gateway node is to communicate information from the BLE network to the internet-connected cloud IoT server 106 and vice versa.

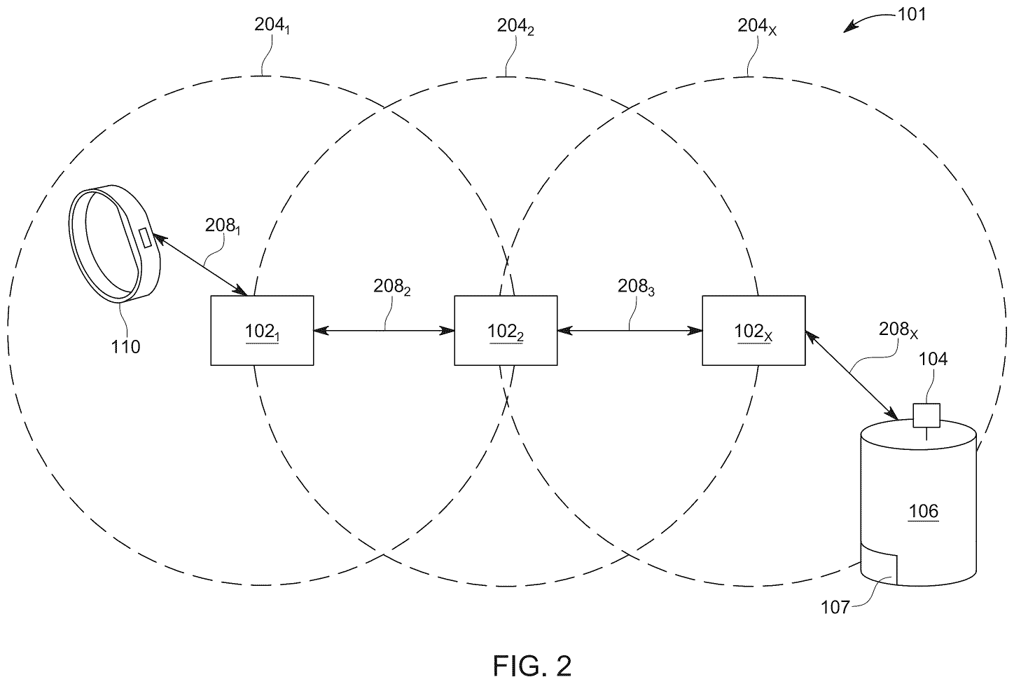

FIG. 2 is a block diagram of the low-energy wireless communication network 101 according to an embodiment. The network 101 includes a plurality of low-energy wireless communication nodes 102₁-102_{X} (also called beacons), each arranged so that it is within a communication radius 204₁-204_{X} of another one of the low-energy wireless communication nodes 102₁-102_{X}. Low-energy wireless communication node 102₁ can receive information from the wearable 110 via low-energy wireless communication link 208₁, and forward the information to gateway node 104 (which is wired to server 106) via low-energy wireless communication beacons 1022 and 102_{X}, using a low-energy wireless communication link 208_{X}. Specifically, low-energy wireless communication node 102₂ forwards the information received from low-energy wireless communication node 102₁ to low-energy wireless communication node 102_{X} via low-energy wireless communication link 208₃, which in turn forwards the information to gateway node 104 via low-energy wireless communication link 208_{X}. In one possible embodiment, the links 202₂, 202₃, and 202_{X} can be formed by encoding information in the packets sent by the wearable 110. In one embodiment, the low-energy wireless communication node 102_{X} can communicate using a wide area network radio, in which case low-energy wireless communication node 102_{X} has two radios, one BLE and one wide area network, but all other nodes have only one radio.

One or more of the low-energy wireless communication node 102₁-102_{X} can add information that is forwarded with the wearable information. For example, low energy wireless communication node 102₁ can include its identification along with the forwarded wearable information, which allows the server 106 to determine an approximate location of the endpoint wireless communication device 110 based on a previously known location for low energy wireless communication node 102₁. In this regard, note that the nodes are located at known positions and these positions are stored in a database 107 and accessed, if necessary, by the server 106. As the BLE communication range is in the order of 10 to 100 m, the position of the nodes 102_{X} are known at the server 106 with an accuracy of 10 to 100 m. Thus, the location of the user of the wearable 110 can be detected with the same accuracy. Also note that this figure shows the wearable 110 communicating with the nodes 102_{X}, but the same is true for the sticker 120. Thus, anything discussed herein with regard to FIG. 2 equally applies to the wearable 110 and the sticker 120.

Additionally, each of the low energy wireless communication nodes 102₁-102_{X} can add their own identification or other information (e.g., scanned advertisements, battery level, etc.) to the forwarded wearable and/or sticker information. This allows the server 106 to perform a number of tasks, such as determining the location of all endpoint wireless communication devices within the node infrastructure, compute and optimizes the local network paths traveled by the wearable and/or sticker information, determine goods or products or services to be supplied to the wearable and/or sticker, order these goods or products or services from appropriate vendors that are stored in the database 107 in the server, and/or other network maintenance tasks. In one application, low energy wireless communication beacons 102₁-102_{X} can form an ad-hoc network and one node can communication with a plurality of other nodes. Note that in this embodiment, each node 102 communicates only with other nodes 102, except for one end node 102ₓ that is also in range to communicate with the gateway node 104. In one embodiment, the nodes 102 exclusively communicate with the other nodes in the network through BLE technology.

Server 106 is configured to identify information associated with the wearable or sticker information (e.g., request for food of a resort quest wearing the wearable, measured temperature of a patient in a hospital, amount of a certain product left in a warehouse, etc.) and process this information to respond to the request (e.g., order the food, provide treatment in response to the measured temperature, or provide further supplies of the product that is low in the warehouse, etc.) and then forwards this information to endpoint wireless communication wearable 110 or sticker 120 using low energy wireless communication nodes 102₁-102_{X} via the low energy wireless communication links 208₁-208_{X}. Specifically, server 106 forwards the associated information via the gateway node 104, through the low energy wireless communication link 208_{X}, to low energy wireless communication node 102_{X}, which in turn forwards the associated information to low energy wireless communication node 102₂ via low energy wireless communication link 208₃. Low energy wireless communication node 102₂ forwards the associated information to low energy wireless communication node 102₁ via low energy wireless communication link 208₂, which then forwards the associated information to endpoint communication device 110 or 120 via low energy wireless communication link 208₁. In one embodiment, low energy wireless communication node 102₁ is configured such that the range of low energy wireless communication link 208₁ is shorter than the range of low energy wireless communication link 202₂ so that endpoint wireless communication device 110 or 120 receives information only related to the location of low energy wireless communication node 102₁.

In another embodiment, server 106 can be replaced by a gateway or other edge device, which communicates with low energy wireless communication node 102_{X} directly via the low energy wireless communication link 208_{X} and which forwards the information to a server in another network using a wired or wireless wide area network communication link. The particular network arrangement in FIG. 2 is but one example of a BLE network and the low energy wireless communication nodes 102₁-102_{X} can be arranged in any type of network arrangement, including a mesh network or a structured network. Further, conventional network techniques, such as self-healing, multi-hopping, etc., can be implemented in network 101.

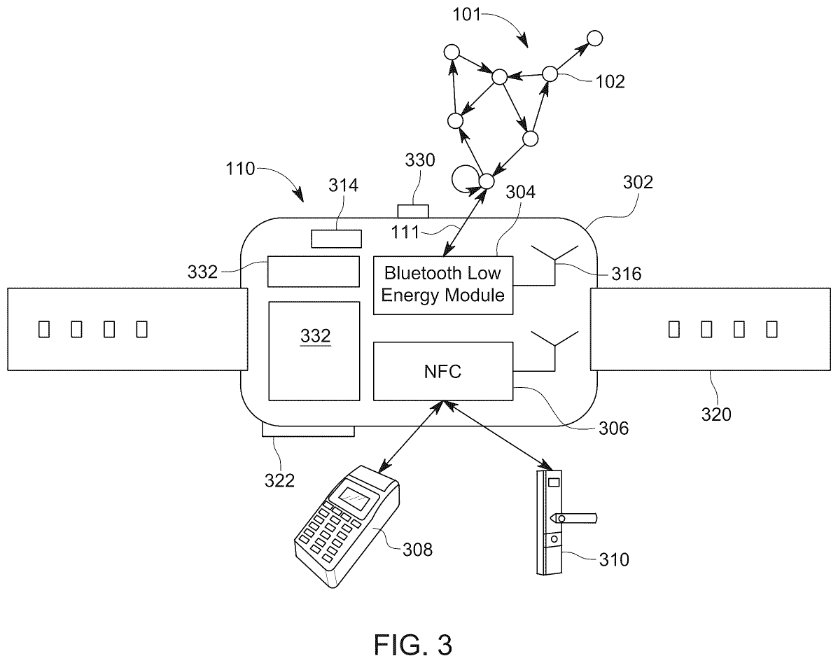

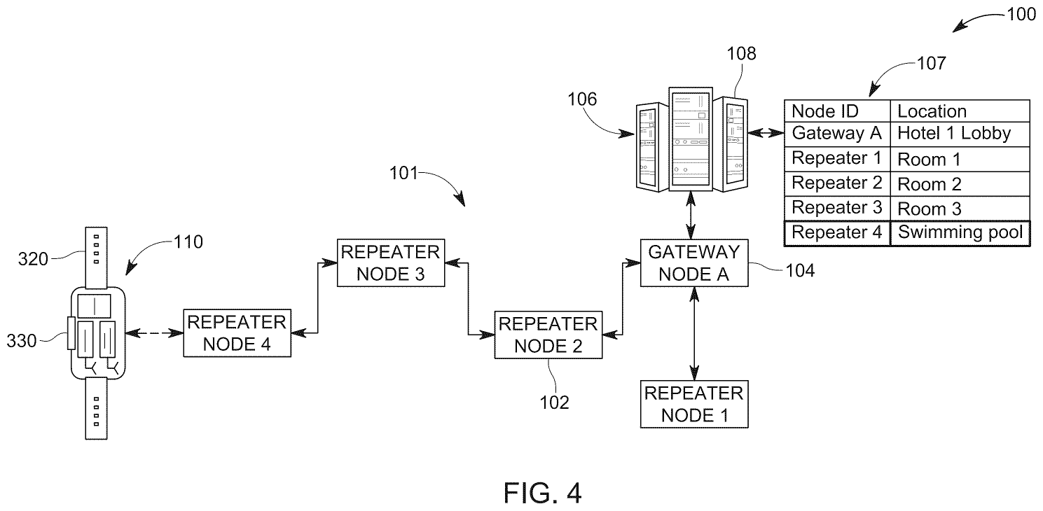

The wearable 110 is configured to be a lightweight, low-cost, and low-power BLE wearable (e.g., in the form of a wrist band). As illustrated in FIG. 3, the wearable 110 is configured to integrate two technologies: BLE and Near field communication (NFC). The BLE module 304, which is formed on or within a flexible substrate 302 (details of which are discussed later with regard to a specific implementation of a skin-temperature measuring wearable) of the wearable, communicates with the BLE network 101 to enable location-based smart services (e.g., product ordering, service ordering, emergency services request, etc.). This is possible because the cloud IoT server 106 maintains a database/record 107 of physical locations at which each BLE repeater node 102 or gateway node 104 is installed, as schematically illustrated in FIG. 4. Thus, by comparing the identification of the BLE node 102 that received data/information (such as a button press) from the BLE wearable 110 or the BLE sticker 120, at the database 107 of the cloud IoT server 106, to a map 108, also stored at the server 106, the physical location of the BLE wearable or sticker can be determined. This makes it possible to provide many location-based services to the user of the wearable. Note that FIG. 4 shows only one wearable 110 for simplicity. In an actual system 100, there are plural wearables 110 and plural stickers 120.

FIG. 3 also shows the wearable 110 including an NFC module 306, which may be configured to communicate with a point-of-service (POS) device 308 of digital payments for implementing online payments or with an access control unit 308 for opening or closing a door. The NFC module 306 may also be configured to open a lock 310 of a specific door, for example, the door from the resort room where the wearer is staying, or the door of a patient room in a medical environment, or a specific storing chamber in a warehouse, or the door of a vehicle, etc. Both the NFC module 306 and the BLE module 304 may be made of flexible materials, as disclosed, for example, in U.S. Pat. Nos. 10,952,412, 10,845,213, 11,127,585, and 11,545,436, assigned to the assignee of this application, so that the entire wearable 110 is flexible, i.e., is conforms to a curved object, for example, the wrist of the person wearing the wearable. Note that the existing smart watches are not flexible, as these devices do not bend to take the shape of the wrist of the wearer.

The wearable 110 further includes a battery 312, and a processor 314 that controls the modules 304 and 306. Each of the modules 304 and 306 has a corresponding antenna 316. All these elements are made to be flexible so that the entire wearable (similarly for the sticker, although not necessary) is flexible, i.e., conforms to a curved object. In the embodiment shown in FIG. 3, the wearable 110 is attached with a band 320 to the hand of the user. However, in one embodiment, the wearable 110 has no band, but a sticky layer 322 on the back of the substrate 302 for being attached to the skin of the user. Sticky layer 322 may include any adhesion biocompatible substance for sticking to the skin of the user. After the wearable 110 was used in the resort, or hospital, or hotel or whatever smart community is selected, the wearable may be disposed. In one application, for safety issues, the wearable 110 is shredded when the user is leaving the smart community. To be able to provide the payment services and also the unlocking services (in fact for any service), the wearable is encoded when the guest arrives at the smart community, as the traditional hotel room card is programmed when the guest first arrives to the hotel. In this case, as payments and other confidential information are associated with the wearable, a more sophisticated procedure may be used for encoding this information into the disposable wearable. For example, the smart phone of the user needs to be processed at the time the wearable is encoded so that confidential information from the secure smart phone is associated with the wearable.

For this purpose, the NFC module 306 of the BLE wearable 110 encodes a unique ID. The IoT cloud server 106 maps this ID to all data related to the user, such as government identification documents, room/door access, digital wallet information for seamless payments, etc. By virtue of this wearable, several location-aware services, emergency response services, as well as enhanced hospitality services can be enabled. For instance, a visitor in a resort does not need to carry any ID documents, room keys, or wallet and instead access to all these services is achieved through the wearable.

The wearable may also include at least one button 330, as shown in FIG. 3, for choosing one service or product when a plurality of them are available. The button 330 may work in conjunction with a flexible screen 332. When the wearable is located next to a given node 102, that node is associated with all the services that are available at that location. Thus, the node 102 provides to the wearable 110 the categories related to those services, and these categories are displayed on the screen 332. The user then selects with the button 330 the desired category (for example, products, leisure services, emergency services, health services, etc.) and then controller 314 provides all the specific items associated with the selected category (for example, food, drinks, flowers, rides, medicine, call 911, call a doctor, need towels, etc.). The user will use again the button 330 to select the desired product or service. The network 101 then takes care to order that product or service and to deliver it.

The BLE sticker 120, which is the third element in the system 100, is also configured to be lightweight, printed, low cost, and flexible. These BLE stickers can be attached to any asset for management and tracking. It operates by periodically broadcasting a unique ID and, optionally, a variable quantity, for example, the number of mustard bottles in the pantry, or the number of syringes in a unit of a hospital, or any other indicator associated with a certain resource in the smart community. Similar to the BLE wearable, these BLE stickers work in conjunction with the BLE mesh network 101. Periodic ID broadcasts and current values of the variable quantity by these stickers are received by the BLE mesh network and multi-hopped to the cloud IoT server 106. By comparing the identification of the network node 102 that received the ID broadcast from the BLE sticker 120, to its physical location in the database 107 at the cloud IoT server 106, the location of the BLE sticker 120 and the asset to which it is attached can be determined. Then, by comparing the value of the variable quantity with a desired threshold also stored in the database 107, the server 106 can determine that the respective product has a low inventory, and it automatically orders that product from the appropriate vendor. The value of the variable quantity may be changed, for example, with the help of a button provided on the sticker (similar to button 330 on wearable 110). This means that when the person in the restaurant uses a bottle of mustard from the pantry, he or she presses the button to indicate that one less bottle of mustard is left in the pantry. The sticker 120 decreases the value of the variable quantity by one, any time that the button 330 is pressed. In this way, the number of products left in the pantry is current. Note that each product may be associated with a corresponding sticker. In one application, the structure of the sticker 120 is similar to the structure of the wearable 110 shown in FIGS. 3 and 4, except that the NFC module 306 and the band 320 are omitted.

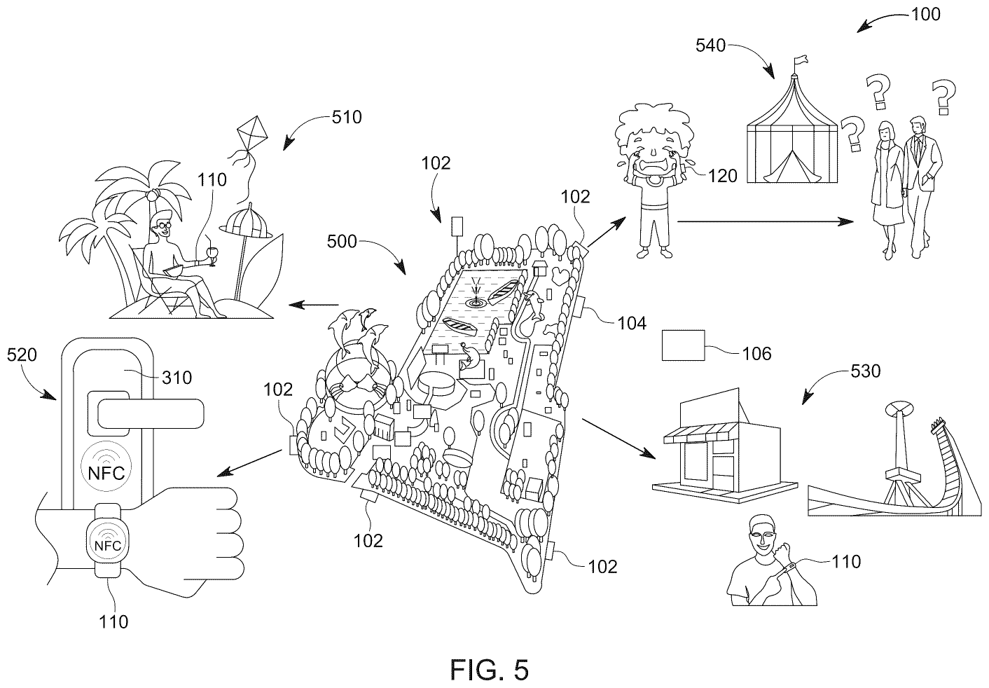

The system 100 may advantageously be implemented in a resort 500, as illustrated in FIG. 5, to take advantage of all the features discussed herein. FIG. 5 shows the wearable 110 being used, at a first location 510, for example, on the beach, for ordering food from a location outside a restaurant, and paying with the same wearable for the food. At location 520, for example, in a hotel, the same wearable may be used to open the lock 310 associated with a room. At location 530, the same wearable 110 may be used to buy, for example, a ride ticket for a given ride. At location 540, for example, at an attraction, the parents of a child can use the location of a sticker 120 attached to their kid to determine his or her location when the child is lost. Many other services and/or products may be ordered using the wearables and/or stickers discussed herein.

A specific implementation of the wearable 110 is now discussed in the context of measuring the skin temperature of the user. Those skilled in the art would understand that the wearable 110 does not have to measure any parameter of the user. The configuration now discussed can also apply to sticker 120. The same configuration may be used for a wearable that performs no measurements.

The wearable 110 may be purposed for monitoring one or more conditions of the wearer. For example, the wearable 110 may be configured to measure the skin temperature of the wearer. Those skilled in the art would understand that other parameters may be measured, for example, humidity, pressure, acidity, etc. The rapid adoption of Healthcare-Internet-of-Things (H-IoT) applications has enabled significant improvements in the quality and cost of healthcare services, particularly by leveraging personal H-IoT devices such as on-body sensors. Data collected by personal healthcare devices allow patients to monitor their vital signs in real time without the need for a healthcare provider while hospitals have continuous access to the collected data through the internet. Therefore, the development of on-body sensors has gained enormous attention for monitoring biophysical conditions such as heartbeats, chronic wounds, blood pressure, lactate concentration, and skin temperature. Skin temperature is one of the most important vital signs as it indicates health conditions such as viral or bacterial infections, tissue inflammation, and antigenic reactions. Furthermore, many precautionary pandemic protocols require manual inspection of individual temperature, necessitating real-time mass monitoring of human body temperature.

However, on-body worn temperature sensors must meet a unique set of requirements such as flexibility for skin conformation, high sensitivity to detect small temperature changes, and stability against agents, i.e., water absorption from the environment or sweat. Moreover, a sensor's cost and power consumption are critical considerations for IoT applications. Printed temperature sensors are a perfect fit for body sensing applications because they can be mass produced through simple fabrication processes like screen or inkjet printing and can leverage low-cost recyclable materials such as Polyimide (PI), Polyethylene Terephthalate (PET), and Polyethylene Naphthalate (PEN).

Much effort has been dedicated to designing printed flexible temperature sensors using a variety of thermosensitive materials. For example, a printed temperature sensor based on Poly (3,4-ethylene dioxythiophene): Poly (styrene sulfonate) (PEDOT:PSS) was demonstrated in [9, 10]. It exhibited a sensitivity of 0.77%.° C.⁻¹ with stable performance in up to 80% relative humidity. Despite its high stability, the sensor's sensitivity was insufficient for detecting very

small variations in skin temperature. In another study [11], a highly sensitive skin attachable temperature sensor based on a poly (N-isopropyl acrylamide)-(pNIPAM) hydrogel with a sensitivity of 2.6%.° C.⁻¹ was reported. However, the reported sensitivity had a temperature resolution of 0.5° C., which is unsuitable for skin temperature monitoring as skin temperature typically varies with much higher resolutions (˜0.1° C.). Several previously reported metallic materials-based printed temperature sensors used materials such as Silver (Ag), Carbon Black (CB), Graphene, Gold (Au), and Vanadium Dioxide (VO₂) [12]. However, none of these sensors achieved all the desired characteristics for a good flexible, inexpensive, disposable, temperature sensor.

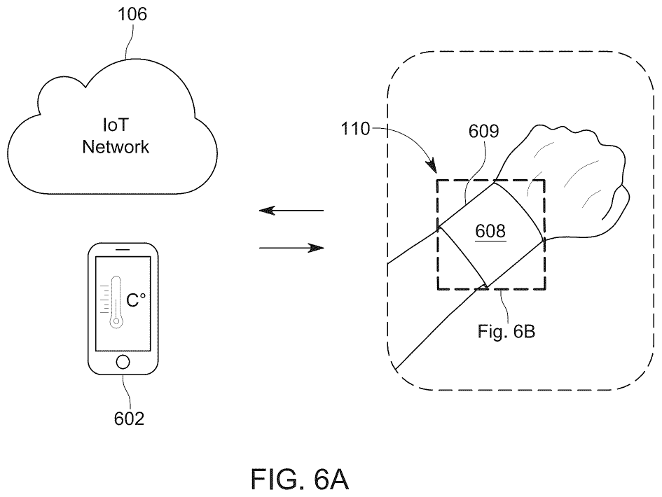

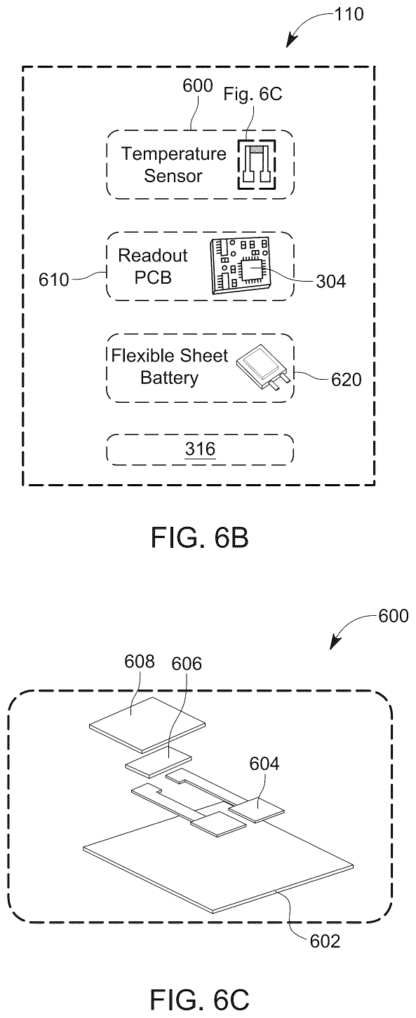

A wearable 110 that is modified to measure temperature and overcome the above noted limitations of the existing temperature sensors is now discussed with regard to FIGS. 6A to 6C. Wearable 110 is printed on a wrist band that is attached to the hand of the user. Wearable 110 is configured to communicate, via BLE communication, with a smart phone 602 or the server 106. Wearable 110 may include, in addition or instead of the structure shown in FIG. 3, a temperature sensor 600 and a readout PCB 610, which supports the BLE module 304. Note that flexible battery 312 shown in FIG. 3 is implemented herein as flexible sheet battery 620. In one application, the readout PCB 610 is also flexible. FIG. 6C shows the temperature sensor 600 being made on a flexible (e.g., polyimide having a thickness of about 125 μm) substrate 602. A pair of electrodes 604 (e.g., made of silver and having a thickness of about 25 μm) is located on the substrate 602. A doped VO2 layer 606 is electrically and mechanically connected to the ends of the electrodes 604. In one application, they have a thickness of about 25 μm. The doped VO2 layer 606 is covered with an encapsulation layer 608, and has a thickness of about 2 μm.

The temperature sensor 600 (which is located as closed as possible to the skin) varies in resistance with changes in temperature, which are converted to digital signals by the readout circuit 610. The readout circuit 610 correlates the sensor's resistance with skin temperature through a look-up table based on the sensor's characterizations. Subsequently, the readout circuit continuously sends measured temperature values to a user's smartphone 602 or the cloud server 106 via a wearable patch antenna 316 (located furthest from the skin). To ensure low cost, the wristband 609 (see FIG. 6A) may be screen printed using inexpensive recyclable materials, including PET and PI, which are among the most recyclable plastic materials. In one application, the wristband 609 is the substrate 602 on which the sensor 600 is formed. In one application, the antenna 316 is located on one side of the wristband 609 and the readout PCB 610 is located on the other side of the wristband. These thermoplastic polymers have excellent flexibility at small thicknesses, which is desirable for conformation to the human wrist.

Although for humans the skin temperature is not the same as core body temperature, studies have shown that skin temperature can be used as an indicator for human health conditions. Usually, normal skin temperature ranges between 31° C. and 36.9° C. and fluctuates by 0.5° C. throughout the day due to physical activity. Generally, a patient with a skin temperature above 37° C. is considered to have a fever. Therefore, small variations in skin temperature (˜0.1° C.) must be detected by a temperature sensor to ensure sufficient resolution for the remote monitoring of human health.

Different types of temperature sensing mechanisms are based on a material's physical changes, i.e., thermo-sensitive resistors (thermistors) are widely used in printed sensors due to their simple structure and high sensitivity. Thermistor sensitivity is measured using the temperature coefficient of resistance (TCR), defined as the percentage of resistance change per temperature change from room temperature expressed by:

$$TCR = \frac{R - {R}_{0}}{{R}_{0} \cdot Δ T} \cdot 100 \% ,$$

where R is the resistance at the measured temperature, R₀ is the resistance at the reference/room temperature (25° C.), and ΔT is the change in temperature from room temperature.

Because the sensor 600 is attached directly to the user's skin, it is exposed to water molecule absorption from the environment or sweat. Therefore, it must be stable against these conditions to ensure reliable and accurate measurements. For wearability, the temperature sensor must also be robust against bending. Lastly, the fabrication process must be repeatable with sample consistency for the sensor to be practical for mass production.

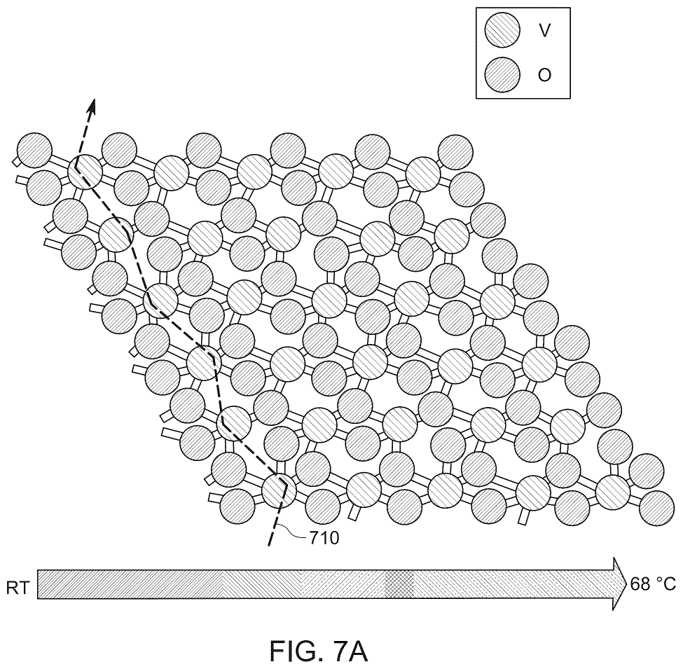

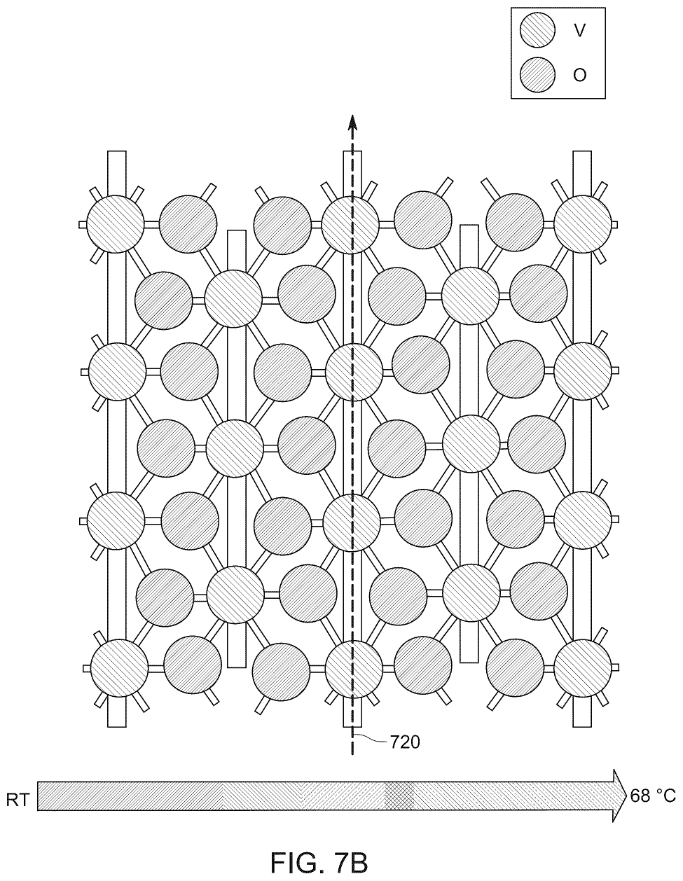

The inventors previously developed in vanadium oxide (VO₂) based particles and processed them into a screen-printable ink. The VO₂ nanoparticle-based ink compositions were used for radio-frequency (RF) switching applications. VO₂ is a Metal-Insulator-Transition (MIT) material that exhibits a monoclinic structure (M phase), which corresponds to an insulating or semiconducting state due to Vanadium-Vanadium (V-V) zigzag chains 710 in its crystal structure, as illustrated in FIG. 7A. However, when the temperature is greater than T_{MIT}, VO₂ adopts a rutile structure (R phase), which corresponds to a metallic state due to the linear arrangement 720 of V-V atoms, which is illustrated in FIG. 7B. The change in the state of VO₂ from an insulator to a conductor and vice versa makes it attractive for use in optical and electrical devices. As the VO₂ (M) phase experiences the MIT at a temperature of 68° C., a highly sensitive temperature sensor can be realized near the MIT temperature.

However, for a temperature sensor for measuring the skin temperature, which is around 30° C. to 40° C., the T_{MIT} of VO₂ (M) (68° C.) is relatively high, and such a sensor will not meet the standard for generating medically reliable data. Thus, the inventors have discovered that the sensor's T_{MIT} could be lowered to achieve higher sensitivity near the skin temperature range. T_{MIT} tuning is feasible through doping using metals such as Fluorine (F), Phosphorous (P), and Tungsten (W) [14, 15]. The added dopant adds extra electrons in the valence states, which decreases the T_{MIT} of VO₂ (M) [16].

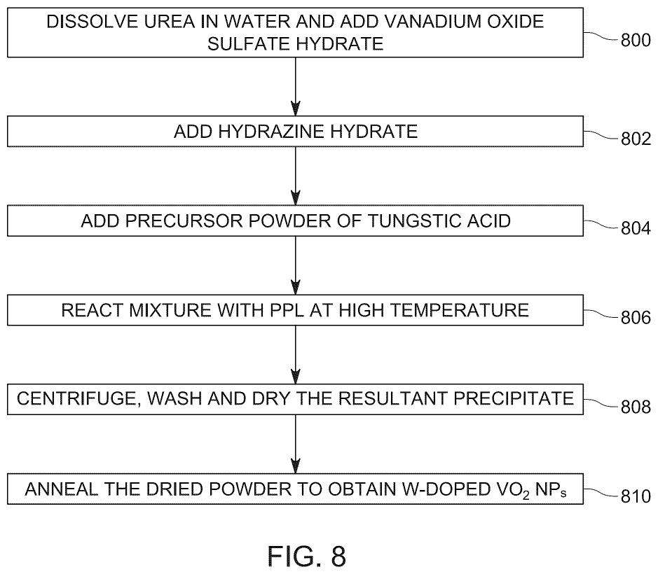

The inventors have doped the VO₂ material with W atoms to lower the T_{MIT} close to the skin temperature so that the temperature sensor 600 is most sensitive to the skin temperature. More specifically, as schematically illustrated in FIG. 8, the method of doping VO2 nanoparticles (NPs) starts with step 800 of first synthesizing the VO₂ NPs by dissolving Urea Pellet (1.8 g, NH₂CONH₂) in 150 ml DI water and then adding Vanadium (iv) Oxide Sulfate Hydrate (2.445 g, VOSO₄·xH₂O) powder. The resultant mixture is mixed well in step 802, followed by the addition of 0.9 ml Hydrazine Hydrate (10% solution in water, N₂H₄, reagent grade).

The obtained VO₂ NPs are then doped. For this process, different molar concentrations (0.001-0.004 M) of precursor powder of Tungstic acid, which is the source of the W element, are separately added in step 804 to the as-resultant mixture of VO₂ NPs, followed by 15 min of ultrasonication. Then, the final solution is transferred in step 806 to about 200 ml Polypropylene (PPL) high-temperature polymer-liner-based hydrothermal autoclave reactor. The reaction temperature is set to about 260° C. for about 6 hours. After completion of the reaction, the resultant black precipitate is centrifuged, washed with water and ethanol, and dried in a vacuum oven, in step 808, at about 70° C. for about 1 hour. The dried powder is then annealed in step 810, at about 300° C. for about 3 hours in a vacuum oven to obtain the W-doped VO₂ (M) NPs.

The doped VO₂ material needs to be fabricated as a film/layer 606 (see FIG. 6C) to realize the skin temperature sensor 600. Traditionally, VO₂ films are prepared using dry vapor processes requiring an ultrahigh vacuum (10⁻⁶ Torr) and high processing temperatures (400-600° C.), expensive masks and nanolithography for device prototyping, which makes them unsuitable for low-cost mass manufacturing. Alternatively, a solution-processed spin coating can be used; however, large-area processing and direct patterning are infeasible using this technique. In contrast, printing techniques (such as inkjet or screen printing) enable extremely low cost, completely digital, and highly scalable manufacturing processes. Thus, printing is attractive for the fabrication of such devices and the inventors have previously described a VO₂ ink for radiofrequency (RF) switching applications [17, 18].

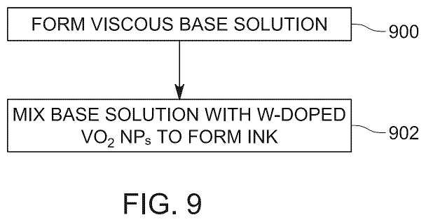

A method for making an ink that includes the W-doped VO₂ NPs is now discussed with regard to FIG. 9. In step 900, a viscous base solution with organic binder is made by mixing terpineol (ACS reagent), Ethyl Cellulose (EC), and Ethanol (>99%) at a weight percentage ratio of about 74:18.5:7.5%. A mixed solvent of terpineol (due to its high viscosity) and ethanol (due to its low surface tension) were selected for use for this ink. In addition, EC acts as an organic binder, a dispersing agent, and a rheological modifier. The obtained doped and undoped-VO₂ NPs from step 810 are mixed in step 902 with the prepared base solution at a weight ratio of about 3:5, followed by agitation to obtain a stable ink with a NP content of 37.5 wt. %. The developed ink was used to print the sensor 600 and stable printing was observed.

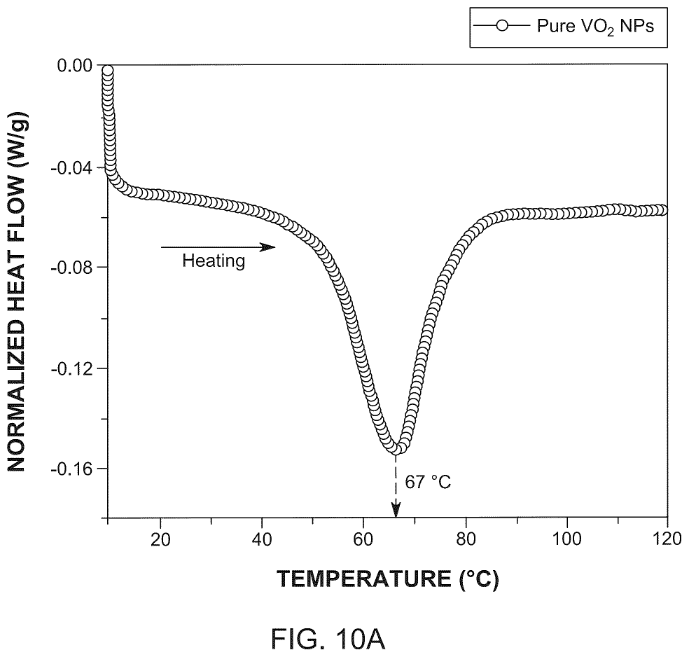

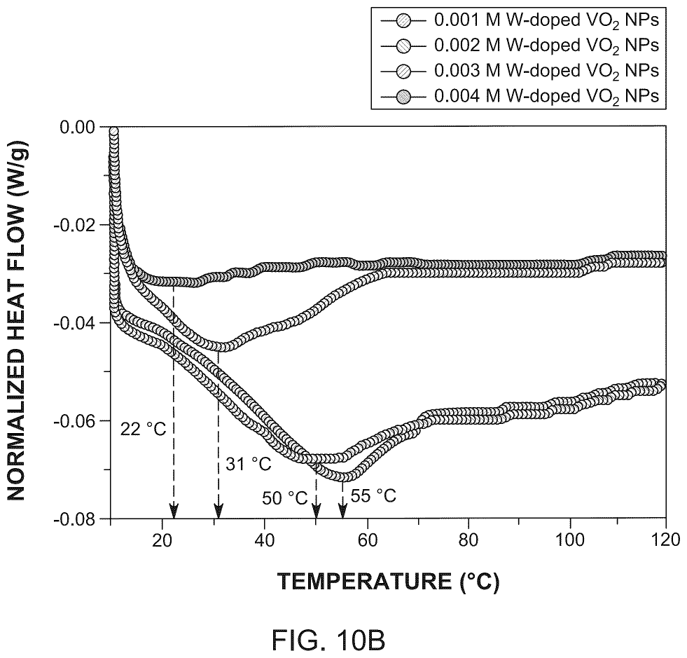

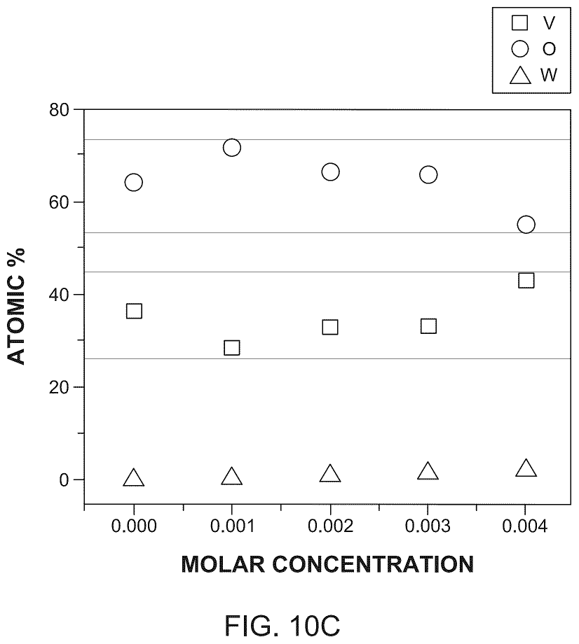

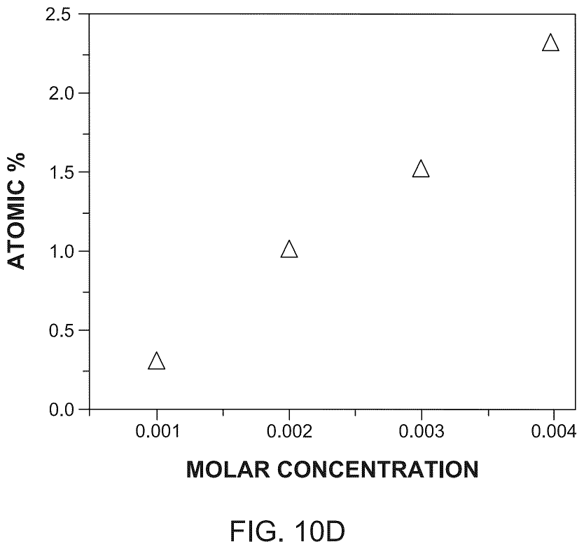

To confirm the doping of the VO₂ NPs and the tuning of T_{MIT}, the doped and undoped-NPs are characterized using differential scanning calorimetry (DSC) as shown in FIGS. 10A and 10B. A clear MIT peak can be seen at about 67° C. for the undoped sample (Sample A), and a shifted broad peak (between 20 to 50° C.) centered at 31° C. is observed for the 0.003M doped sample (Sample B). Furthermore, as the dopant concentration is increased (from 0.001 to 0.004 M), T_{MIT} shifts to lower values. For example, the 0.001 M-doped sample has a T_{MIT} of 55° C., which decreases to 50° C. while for the 0.002 M and 0.004 M-doped samples, the T_{MIT} decreases to 50° C. and 21° C., respectively. This T_{MIT} shifting is attributed to lattice distortion and electron correlations. As other doped concentrations (0.001, 0.002 and 0.004 M) do not shift the T_{MIT} to the desired target range (i.e., around the temperature of the skin), the 0.003 M concentration (Sample B) was selected for further characterization. The W-doping in VO₂ NPs is further confirmed by its corresponding energy dispersive X-ray (EDX) analysis, as shown in FIGS. 10C and 10D. As the W-dopant concentration increases, the atomic % of W also increases, which confirms the successful doping of elemental W in VO₂ NPs. Note that FIG. 10C shows the atomic percentage of the V, O, and W atoms in doped VO₂ powder (which was used to print the sensing layer 606) while FIG. 10D shows only the W atomic percentage in the same doped VO₂ powder. FIG. 10D illustrates that the W atomic percentage in the sensing layer 606 is about 1.5%, with a range between 1.25 and 2% out of the total number of atoms in this layer.

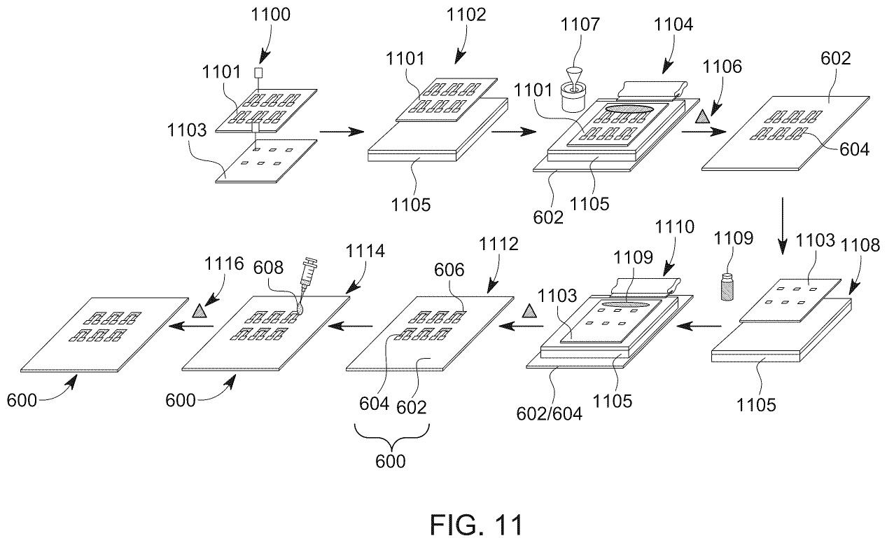

A method for making the sensor 600 with the W-doped VO₂ NPs is now discussed with regard to FIG. 11. Note that the same method may be used for making any wearable 110 or sticker 120. In step 1100, the masks (1101 and 1103) for the Ag electrodes 604 and VO₂ sensor are created using a CO₂ laser cutting machine on a PI tape (50 μm thickness in this embodiment, but different thickness may be used) with adhesive backing. In step 1102, the PI tape-based 1101 is cleaned using Ethanol and attached to a blank mesh screen 1105 for printing. The 53.34 cm×53.34 cm screen mesh (other values may be used) is made of stainless-steel with a 325-mesh count and 22.5° mesh angle. Before printing the electrodes in step 1104, the PI substrate is washed using deionized (DI) water, ethanol, and Isopropanol (IPA), then dried at 80° C. for 5 minutes to improve its surface cleanliness and wettability. For printing, a screen-printing system with a speed of 220 mm s⁻¹ is used. The Ag NP electrodes (with dimensions of 10 mm×8 mm, and a gap of 3 mm for the VO₂ (M) film) are screen-printed in step 1104 using a conductive silver paste 1107 on the PI substrate 604. This is followed by annealing the printed samples in a conventional oven at 210° C. for 1 hour in step 1106. The annealed silver electrodes 604 have a resultant thickness of 25 μm, which is measured using a surface profilometer. High printing quality images (not shown) were obtained for the fabricated samples, where sharp edges with no visible cracks are apparent. The scanning electron microscopy (SEM) images (not shown) shows excellent sintering of the Ag NPs, which is clear from the proper interconnection of the melted NPs. Some gaps are expected in such cases due to the binding polymer. High-quality sintering was also confirmed by separate conductivity measurements of the printed electrodes with a four-point probe method, which showed a high conductivity of 1.8×107 Sm⁻¹.

In step 1108, mask 1103 is attached to the mesh screen 1105 so that the VO₂ ink can be printed between the gaps of the electrodes to realize the complete skin temperature sensor 600. In step 1110, VO₂ printing using both un-doped (Sample A) and doped ink (Sample B) 1109 (obtained based on the method of FIG. 9) results in the formation of the W-doped VO₂ NP layer 606, between the ends of the electrodes 604. Sensing films with double-layer printing (corresponding to 25 μm thick VO₂ films) were performed and dried at 120° C. for 30 min in a vacuum oven in step 1112. The image of the printed VO2 layer 606 (not shown) shows sharp edges with no visible cracks, indicating the high quality of printed films. In addition, the SEM image (not shown) confirms that the VO₂ NPs are uniformly embedded in the polymer binders, which corresponds to a stable film. In step 1114, an encapsulation polymer layer (CYTOP) 608 (e.g., having a 4-5 μm thickness) is casted on top of the sensing layer 606 and cured at about 100° C. for about 15 minutes in step 1116. CYTOP is a fluorinated polymer with a low permeability and has shown excellent passivation capabilities against humidity.

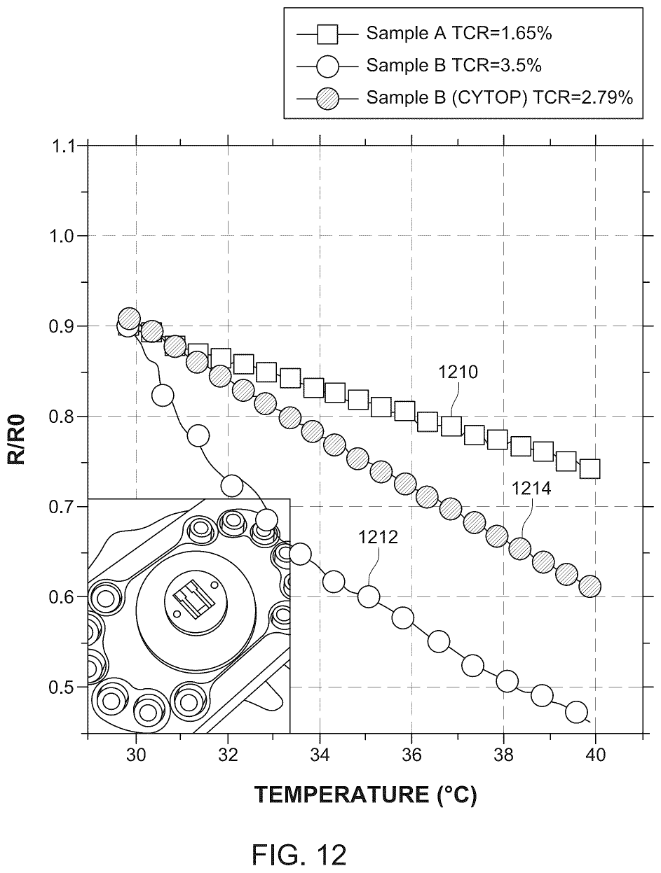

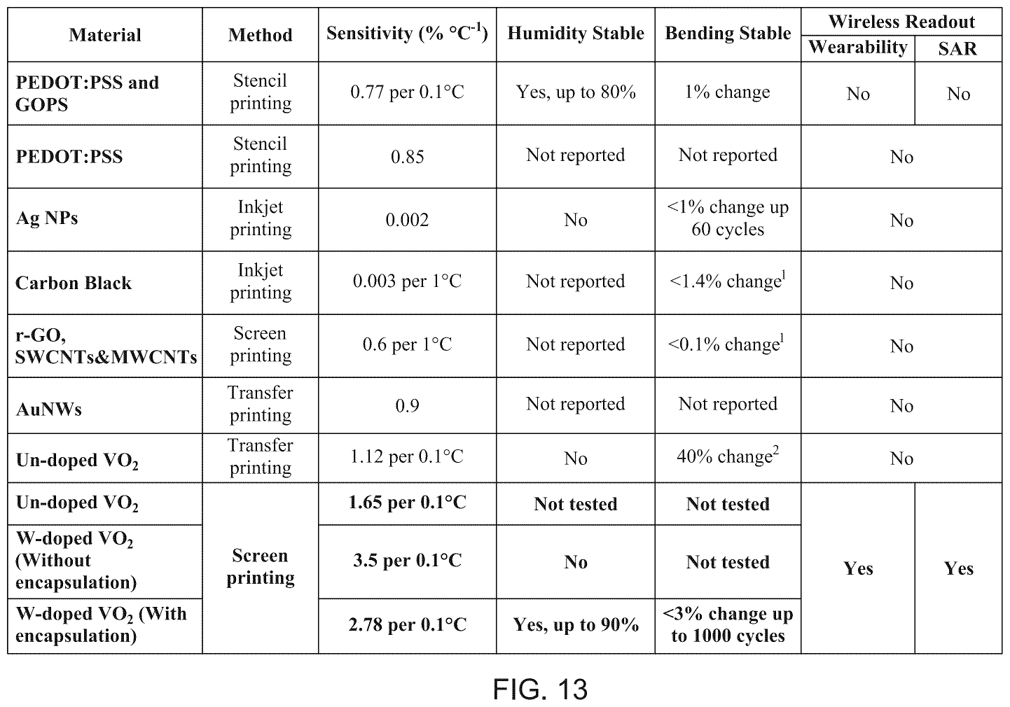

The formed sensor 600 was next tested for determining its characteristics (e.g., sensitivity, stability, reliability, resistance to humidity, wearability, and repeatability performance and reproducibility). To measure sensitivity, a Physical Properties Measurement System (PPMS-ECII)) was used, which measures the resistance of a sample in a vacuum over a specified temperature range. First, the un-doped VO₂ sample (A) was studied for changes in resistance by scanning the temperature with a resolution of 0.1° C. FIG. 12 shows curve 1210 decreasing in resistance with an increase in temperature, indicating a negative temperature coefficient. As previously discussed, this negative correlation is attributed to the VO₂ film transitioning from an insulator to a metallic phase, resulting in decreased resistance of the sensor. The sensitivity (TCR) of sample A is calculated to be 1.65%° C.⁻¹. On the other hand, the doped sample (B) without the CYTOP coating (curve 1212 in FIG. 6) shows a higher sensitivity of 3.5%° C.⁻¹. Thus, tuning the T_{MIT} results in almost doubling its sensitivity. Curve 1214 in FIG. 12 represents Sample B with the CYTOP protective layer. Because the encapsulation layer 608 covers the sensing layer 606, a decrease in sensitivity is observed (2.79%° C.⁻¹). Nonetheless, even this lowered TCR value corresponds to the highest reported sensitivity for a printed temperature sensor, see the detailed comparison between the present embodiments (last three rows in the Table in FIG. 13) and other works (the other rows in the Table).

The inventors also assessed the effect of the humidity on the sensor. Because humidity exerts a strong effect on temperature measurements, and because the VO₂ material is susceptible to water molecule absorption, from sweat in this case, the humidity effect on the developed doped VO₂ sensor 600 was assessed. For this purpose, Sample B, with and without encapsulation, was characterized, at 30° C., in a sealed glass chamber over a hotplate taped and connected to a digital multimeter. The humidity within the sealed chamber was measured using a hygrometer. The humidity in the chamber could be increased by connecting it to a boiling water container, and dry air could be pumped into the container to decrease the relative humidity.

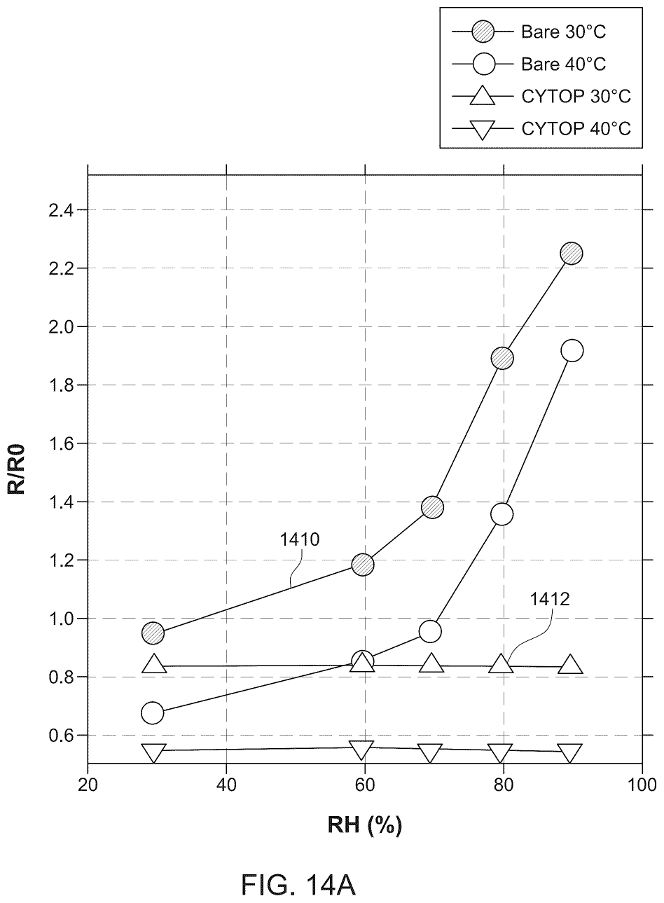

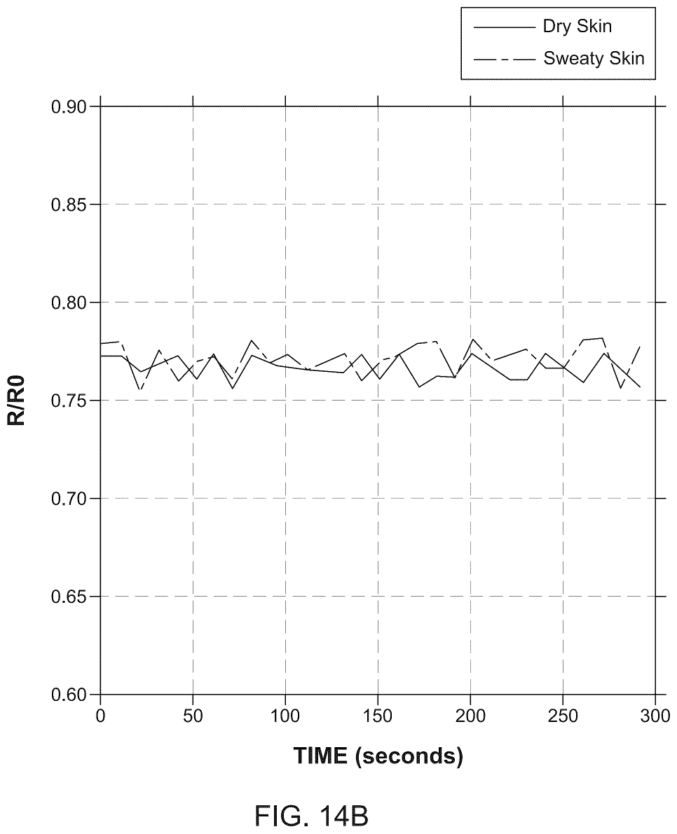

As expected, the sample without encapsulation exhibits a significant humidity effect (RH>40%) on the initial resistance, as shown in the bare sample's curve 1410 in FIG. 14A. The resistance increase is due to the formation of hydrogen surface complexes that transform VO₂ (M) into a different phase, making it unpredictable for practical sensing use. In contrast, the sample with CYTOP encapsulation exhibits a steady initial resistance, despite changing humidity values, as shown by curve 1412 in FIG. 14A. Although there is a slight change in resistance at 90% relative humidity, the temperature error (Tₑᵣᵣₒᵣ) is only 0.01° C. relative to the sensor's resistance at room humidity (RH˜30%). Note that the same trends are obtained when the temperature is 40° C. instead of 30° C.

To further assess the encapsulated sensor 600's stability against water absorption, the sensor was tested on both wet and dry skin. First, the sensor's resistance was measured over time on dry skin. Subsequently, the same measurements were conducted on wet skin. FIG. 14B shows that the sensor's resistance on wet skin is similar to that on dry skin. The fluctuation in both curves is caused by skin temperature fluctuations (±0.2° C.) monitored throughout the test using a commercial handheld IR based thermometer. Meanwhile, the error difference between the two curves corresponds to Tₑᵣᵣₒᵣ of approximately 0.01° C. Hence, this test further confirms the low permeability of the CYTOP layer 608 and the stability of the proposed sensor 600 in the presence of liquid such as water or sweat.

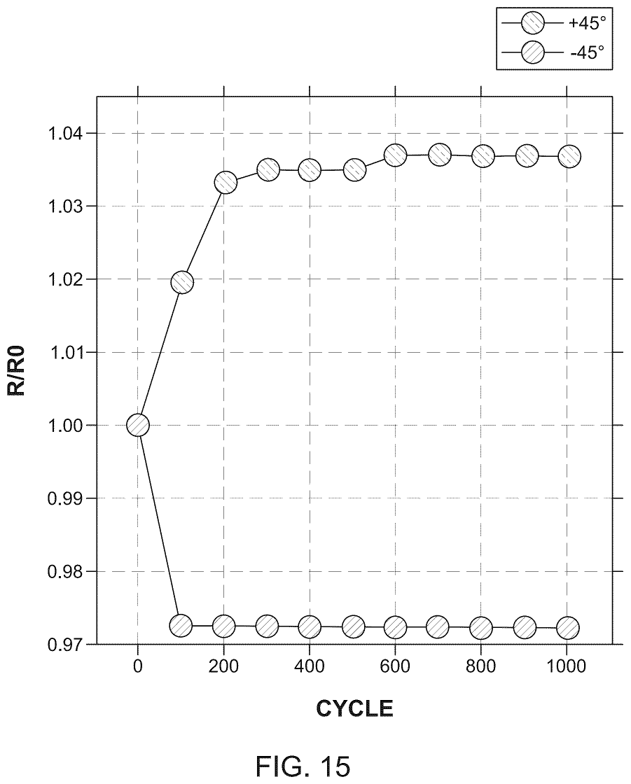

Next, the inventors assessed the bending properties of the sensor 600. The sensor's flexibility is desired because it is attached to a flexible substrate that bends with wrist movement. A 3D-printed bending machine with a step motor that runs bending cycles was used to assess the bending effect on the sensor's resistance. To mimic wearability-related bending situations, the resistance of the sensor was measured when the bent by ±45°. As can be seen in FIG. 15, this bending results in a very small variation in the relative resistance change (R/R₀=±0.032, Tₑᵣᵣₒᵣ=±0.07° C.). This stability against bending is due to the flexible polymer binder's interconnections between VO₂ NPs, which minimizes film cracking under bending conditions and thus maintains consistent film resistance.

The inventors also examined the reusability and reproducibility of the sensor 600. The sensor's reusability was confirmed by repeatedly measuring the resistance of one sample over the skin temperature range. The measured curves of three measurement trials completely overlap, indicating that the sensor has consistent performance over multiple use cycles. This test also confirms the absence of hysteresis, as the temperature is consistently varied between 30° C. and 40° C., and the resultant resistance value is the same at each temperature setting. This is further confirmed by checking for hysteresis at two extreme temperature settings (30° C. and 40° C.) multiple times (not shown). A very small error of ±0.01 in relative resistance (Tₑᵣᵣₒᵣ=±0.03° C.) at each temperature setting is observed, which is not a major concern for accurate measurement of skin temperature.

Reproducibility ensures the consistent performance of a sensor in mass production. Therefore, four identical samples were prepared in a similar but sequential manner and characterized over the skin temperature range. The inventors found that the samples achieve very similar results with sensitivity varying by 0.03%. The results indicate that, despite the low cost and rapid printing process used, the proposed sensor results are consistent, reliable, and reproducible under varying environmental and wearability conditions.

The doped VO2-based temperature sensor 600 was integrated with a wireless readout platform that includes the readout PCB 610 and a wearable antenna 316, powered by the flexible lithium battery 620. The battery 620 has in this embodiment a thickness of 0.5 mm and provides a capacity of 18 mAH in a 40 mm×28 mm package. The readout PCB 610 is responsible for converting the measured temperature values, from the sensor 600, into digital form and transmitting them wirelessly through the wearable antenna 316. The PCB 610 is designed in this embodiment with dimensions of 25 mm×20 mm, which is compact enough to fit an average wrist. A BLE module 304 (for example, BL652 from Laird Connectivity), which is the processing component of the PCB 610, was selected due to its small footprint and ability to support the Smart Basic programming language to enable quick prototyping. Another advantage of the BLE module 304 is that it provides an RF core 312 for communicating with the antenna 316, an embedded Analog-to-Digital converter (ADC) 614, an ARM Cortex processing core 616, and embedded code memory 618. This eliminates the need for any external components and preserves the PCB's compactness.

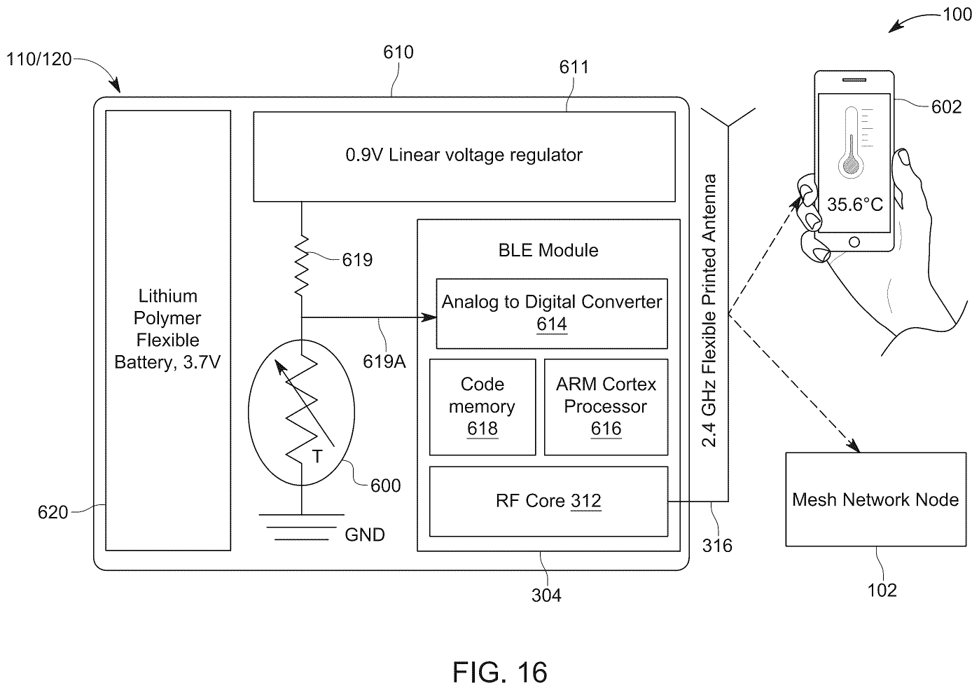

The BLE module 304 transforms the sensor 600's resistance value to voltage through a connected voltage divider (with a shunt resistor 619 that matches the proposed sensor's resistance range (˜50kΩ)), as schematically illustrated in FIG. 16. Note that the device shown in FIG. 16 may be any of the wearable 110 or sticker 120. In one application, the sensor 600 in the figure may be removed or replaced with another sensor. The electric potential from the voltage divider's output 619A is then digitized using the ADC 614, which is subsequently converted to a temperature value using a lookup table (stored in the memory 618) based on the sensor's characterization. However, the sensing layer can be exposed to heat induced by current flow, which may introduce errors in reading skin temperature. Therefore, to limit current flow, a low dropout linear voltage regulator (LDO) 611 is used to restrict the input of the voltage divider to 0.9 V.

A common element of the wearables 110 and stickers 120 is their antenna 316, which is schematically illustrated in FIGS. 3, 6B, and 16. This antenna, which is an integral part of the wireless readout's front-end, is not only the largest component but also the most sensitive to bending and the presence of the human body. General-purpose commercial antennas (chip antennas) cannot be used for such applications because they are not designed for wearability. A custom antenna was designed for the wearables 110 and the stickers 120 as now discussed. Because the antenna is part of the wristband, and due to the high permittivity and loss associated with the human wrist, most of the EM signal generated by the antenna is potentially absorbed by the human body. Thus, the EM absorption of the human body, which is typically quantified through the Specific Absorption Rate (SAR), is regulated by various government norms for the wearables. Hence, the wearable antenna's radiation must be minimal towards the user's body to avoid harmful radiation absorption.

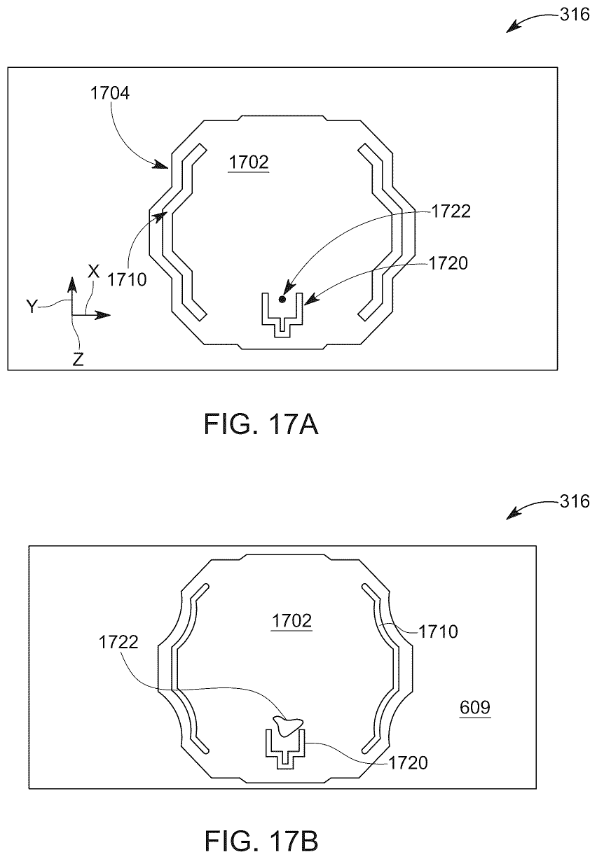

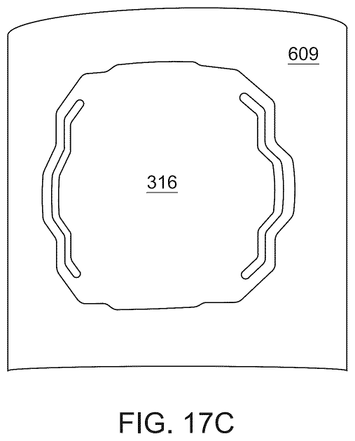

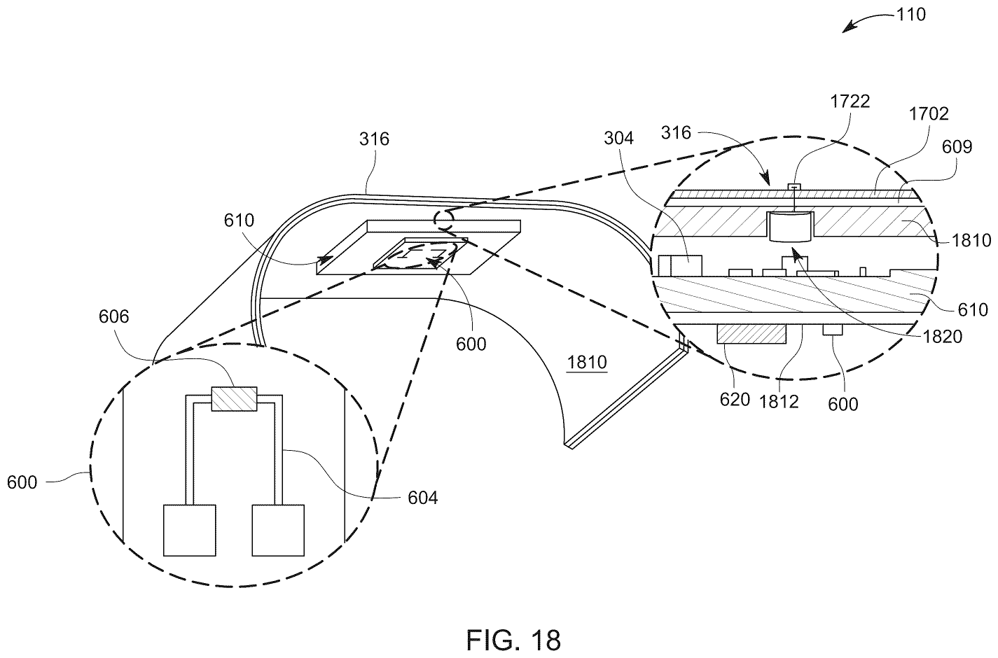

A microstrip patch antenna 316 (see FIGS. 17A to 17C) with a full ground plane was used in one embodiment for wearables 110 and stickers 120 due to its planar structure and minimal back lobe radiation. In this embodiment, the microstrip patch antenna 316 was printed with silver paste (forming a metallic plane 1702) directly on a PET substrate (wristband 609 in FIG. 17B) with 0.5 mm thickness, a relative permittivity (εᵣ) of 3.1, and a loss tangent (tan 0) of 0.004. The antenna was designed to be resonant at 2.45G Hz; however, the length of the patch is reduced by approximately 7% due to curved sides 1704 along the non-radiating length. Due to the thin substrate, the simulated bandwidth (BW) is only 1%. However, the BLE band requires nearly 3% BW (80 MHz). Therefore, symmetrical resonating slots 1710 at 2.466 GHZ with (λ/2) length are introduced near the patch non-resonating length, as illustrated in FIG. 17A. Additionally, a U-slot 1720 is introduced, next to the feeding port 1722, to improve the impedance matching of both resonances. The slots 1710 effectively widen the antenna's bandwidth, encompassing the entire communication protocol frequency range. Furthermore, achieving impedance matching for both the primary resonance (main patch) and the supplementary resonance (slots) is facilitated through the strategic implementation of the U-slot 1720 encircling the feeding port. This U-slot configuration enables fine control over surface current distribution, consequently regulating the impedance characteristics at the feeding port 1722. FIG. 17B shows the flexible antenna 316 being printed with silver paste 1702 on the flexible substrate 609 while FIG. 17C shows the printed antenna 316 bending in unison with the wristband 609 to conform to the wrist of the user. Note that FIGS. 17A to 17C show only the top of the antenna 316. The full ground plane may be a silver paste 1810, as illustrated in FIG. 18, which is formed on one side of the wristband 609. Thus, the wristband 609 may act as a dielectric layer between the silver paste 1702 and the silver paste 1810, that form the antenna 316. FIG. 18 further shows the wearable 110 including the integrated antenna 316, temperature sensor 600, PCB readout circuit 610, and battery 620. A radio frequency connector 1820 (for example, MH4) is used to connect the feeding port 1722 of the antenna 316 to the PCB readout circuit 610. In this embodiment, the BLE module 304 is attached to the first side of the PCB readout circuit 610 and the temperature sensor 600 is attached to the second side of the PCB readout circuit 610, which is opposite to the first side. The antenna 316 is attached to BLE module 304, on a side opposite to the PCB readout circuit 610. As discussed above, the antenna 316 may be formed around the wristband 306. Thus, the sensor 600 is closest to the skin of the wearer and the antenna 316 is the farthest from the skin. The battery 620 may be attached to the wristband 609 or to the copper foil 1812 of the PCB readout circuit 610.

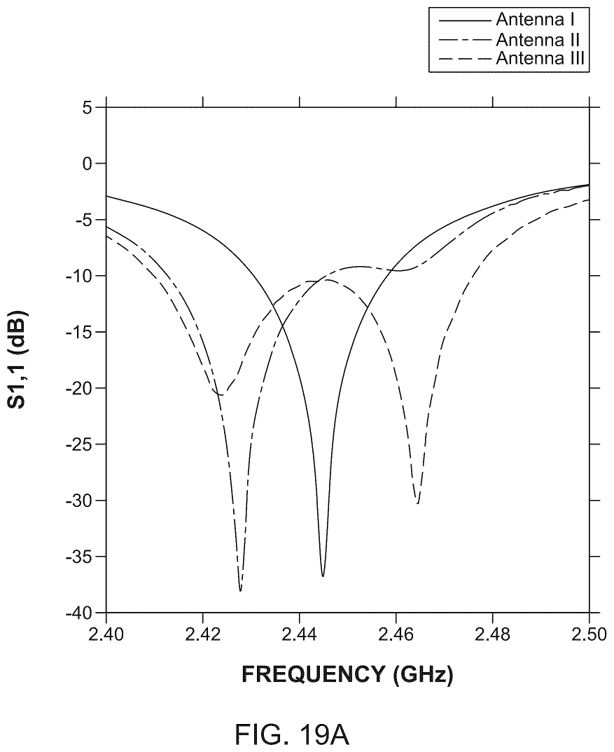

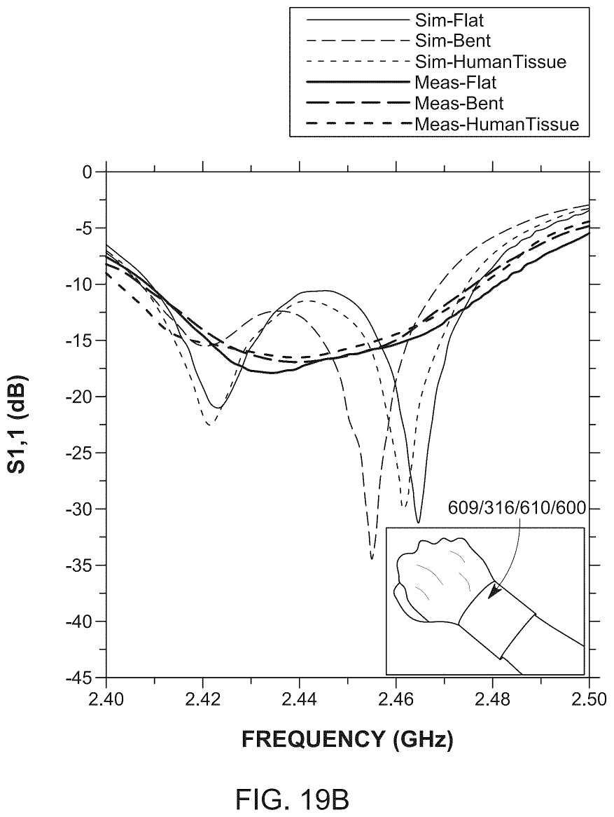

The reflection coefficient (S11) of (I) an antenna with no resonating slots 1710 and no U-slot 1720, (II) an antenna with resonating slots but no U-slot, and (III) the antenna 316 of FIGS. 17A-C were simulated as shown in FIG. 19A. The simulated SAR value using 4 dBm input power is only 0.068W/kg averaged over 10 g human tissue, which is below the safety standard. For the flat condition, the simulated model has a primary resonance at 2.42 GHz and a secondary resonance at 2.46 GHz with an impedance bandwidth (<−10 dB) of 67 MHz, as shown in FIG. 19B, and realized gain of 1.9 dBi. However, the measured sample two resonances are merged due to a small shift in the secondary resonance to result in a bandwidth of 3% (72 MHz) and 1.65 dBi gain. As it can be noticed from the bending effect and the human tissue effect results in FIG. 19B, there is a slight reduction in the secondary resonance resulting in a simulated and measured bandwidth of 67 MHz and 68 MHz, respectively. For this configuration, the BW is increased to 2.8%. The results indicate that the antenna's performance on the human body is similar to its performance in air. An excellent SAR value of 0.068 W/kg averaging over 1 g of human tissue is obtained. Note that this SAR value is considerably below the safety limit of 1.6 W/kg specified by the Federal Communication Commission (FCC). The antenna 316 may be printed through the same process as that of the sensor electrodes described in FIG. 11.

The antenna 316 illustrated in FIGS. 17A to 17C may be implemented in any of the wearable 110 and stickers 120 of the system 100. This antenna is specifically configured to accommodate BLE communication with the BLE network 101. The patch antenna 316, which incorporates the full ground plane (reflective plane) 1810 serves a dual purpose-shielding the antenna from the absorption-prone human tissue and channeling the entirety of radiated energy toward the designated direction (+Z axis). Although the patch antennas tend to exhibit a narrow frequency bandwidth (BW), the introduction of the symmetrical resonating slots 1710 effectively widen the antenna's bandwidth, encompassing the entire communication protocol frequency range. Furthermore, achieving impedance matching for both the primary resonance (main patch) and the supplementary resonance (slots) is facilitated through the strategic implementation of the U-slot 1720 partially encircling the feeding port 1722. A notable outcome of achieving robust impedance matching is the realization of a gain of 2.5 dBi, a marked improvement when compared with chip antennas that often exhibit negative dBi gains. This antenna configuration can be implemented by using a screen-printing technique on a flexible PET substrate, utilizing a silver paste recognized for its superior conductivity properties. This make the entire wearable 110 or sticker 120 inexpensive and flexible, which achieves the desired goals of conforming to the human skin and being disposable after usage. Thus, the demand of highly sensitive, environmentally stable,

mechanically flexible, and low-cost wearable (e.g., temperature sensors) or stickers can be achieved with one or more of the configurations shown in FIGS. 3, 6A to 6C, 16, 17A to 17C, and 18. Such devices can be worn on-body and provide stability against environmental factors such as water absorption from the environment or sweat to be considered for practical applications. In one application, the wearable or sticker includes doped vanadium oxide-based particles that are processed into a screen-printable ink. The ink-formulation of doped-VO₂ NPs leverage the cost-effective large area fabrication of the wearable or sticker.

The low-cost, printed, and flexible wristband 609 with the VO₂ (M)-based temperature sensor 600 exhibits a high sensitivity of TCR=2.78%·° C.⁻¹ and robust stability against humidity provided by a CYTOP encapsulation layer. The proposed VO₂ (M) temperature sensor shows competitively high humidity stability in up to 90% RH, which makes it very attractive for practical use. In addition, a readout platform with an ultrathin flexible patch antenna has been demonstrated with an excellent bandwidth of 72 MHz despite bending and the presence of human tissue. Moreover, the readout has a sound gain of 1.65 dBi with a minimal SAR value below 0.068 W/kg, which indicates it is safe for near-body use. Furthermore, skin temperature testing shows promising results with a maximum error of ±0.16° C. compared to a commercialized thermometer. While sensor 600 is configured to measure the temperature of the skin, it is noted that similar technologies may be used for constructing any desired sensor for the wearable 110 and sticker 120. In one application, no sensor is built into the wearable or sticker, only the components illustrated in FIG. 3.

The term “about” is used in this application to mean a variation of up to 20% of the parameter characterized by this term. It will be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

The disclosed embodiments provide a BLE system, BLE wearable and BLE sticker that are configured to be flexible, inexpensive, disposable and also provide enhanced experience to a guest of a smart community. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

### REFERENCES

The entire content of all the publications listed herein is incorporated by reference in this patent application.
[1] U.S. Patent Application Publication no. 2020/0015100.
[2] See disclosure at store.kontakt.io/product/anchor-beacon/.
[3] See disclosure at minew.com/product-category/lbs-products/bluetooth-beacon.
[4] See disclosure at thetrackr.com/.
[5] See disclosure at thetileapp.com/.
[6] See disclosure at apple.com/sa/airtag/.
[7] See disclosure at apple.com/sa/watch/.
[8] See disclosure at samsung.com/sa_en/watches/all-watches/.
[9] Y.-F. Wang et al., “Fully printed PEDOT:PSS-based temperature sensor with high humidity stability for wireless healthcare monitoring,” Sci. Rep., vol. 10, no. 1, p. 2467, 2020.
[10] S. Tachibana et al., “Flexible printed temperature sensor with high humidity stability using bilayer passivation (2021 Flex. Print. Electron. 6 034002),” Flex. Print. Electron., vol. 6, no. 4, p. 049501, 2021.
[11] J. H. Oh et al., “Fabrication of High-Sensitivity Skin-Attachable Temperature Sensors with Bioinspired Microstructured Adhesive,” ACS Applied Materials & Interfaces, vol. 10, no. 8, pp. 7263-7270, 2018 Feb. 28 2018, doi: 10.102₁/acsami.7b17727.
[12] F. Liao et al., “Ultrasensitive Flexible Temperature-Mechanical Dual-Parameter Sensor Based on Vanadium Dioxide Films,” IEEE Electron Device Letters, vol. 38, no. 8, pp. 1128-1131, 2017, doi: 10.1109/LED.2017.2714260.
[13] U.S. Patent Application Publication No. 2021/0002490.
[14] K.-D. Ufert, “Doping of VO₂ thin films by ion implantation,” Physica Status Solidi A Appl. Res., vol. 42, no. 1, pp. 187-190, 1977.
[15] Z. Shao, X. Cao, H. Luo, and P. Jin, “Recent progress in the phase-transition mechanism and modulation of vanadium dioxide materials,” NPG Asia Mater., vol. 10, no. 7, pp. 581-605, 2018.
[16] Y.-S. Yang, Y. Zhou, F. B. Y. Chiang, and Y. Long, “Tungsten doped VO2/microgels hybrid thermochromic material and its smart window application,” RSC Adv., vol. 7, no. 13, pp. 7758-7762, 2017.
[17] M. Vaseem, S. Zhen, S. Yang, W. Li, and A. Shamim, “Development of VO2-nanoparticle-based metal-insulator transition electronic ink,” Adv. Electron. Mater., vol. 5, no. 5, p. 1800949, 2019.
[18] S. Yang, M. Vaseem, and A. Shamim, “Fully inkjet-printed VO2-based radio-frequency switches for flexible reconfigurable components,” Adv. Mater. Technol., vol. 4, no. 1, p. 1800276, 2019.

1. A Bluetooth low energy, BLE, communication system comprising:
a BLE network-including plural nodes for transmitting a signal in a hop-on manner;
a BLE wearable configured to be attached to a person and to communicate with a first node of the plural nodes-through a first BLE link, wherein the BLE wearable is printable, flexible, and disposable; and
a BLE sticker configured to be attached to an object and to communicate with a second node of the plural nodes-through a second BLE link, or with the first node,
wherein the BLE wearable includes a BLE module for directly communicating with the BLE network, and a near field communication, NFC, module for directly communicating with a point-of-sale device or access control unit,
wherein the BLE module is configured to order a product or a service through the BLE network and the NFC module is configured to pay for the ordered product or service at the point-of-sale device or to open or close an access door.

2. The BLE system of claim 1, wherein the BLE wearable has a sticky layer for being directly attached to a skin of the person.

3. The BLE system of claim 1, wherein the BLE wearable comprises:
a flexible battery;
the BLE module; and
a flexible printed antenna.

4. The BLE system of claim 3, wherein the flexible printed antenna is a microstrip patch antenna that comprises:
a metallic plane configured to be flexible, the metallic plane including two symmetrical resonating slots; and
a feeding port attached to the metallic plane.

5. The BLE system of claim 4, wherein the microstrip patch antenna further comprises:
a U-slot formed in the metallic plane and located around the feeding port.

6. The BLE system of claim 1, wherein the BLE sticker is disposable and the BLE wearable is configured to conform to a curvature of the person.

7. The BLE system of claim 3, further comprising:
a sensor including a doped VO₂ sensing layer, the sensor being configured to measure a temperature of the person.

8. The BLE system of claim 1, further comprising:
a sensor including a doped VO₂ sensing layer, the sensor being configured to measure a temperature of the person.

9. The BLE system of claim 8, wherein the doped VO₂ sensing layer is doped with W atoms.

10. The BLE system of claim 9, wherein the doped VO₂ sensing layer is doped to lower a metal-insulator-transition, MIT, temperature T_{MIT} to about 31° C.

11. The BLE system of claim 10, wherein the doped VO₂ sensing layer includes about 1.5% W atoms to achieve the T_{MIT} of about 31° C.

12. The BLE system of claim 1, wherein the BLE network includes a gateway node, which communicates in a hop-on manner with one node of the plural nodes and also with a server, in a wired or wireless manner, the server being configured to hold a database with details about each node of the plural nodes and associated services available at a location of each node.

13. A Bluetooth low energy, BLE, conformal wearable comprising:
a flexible battery configured to supply electrical power;
a BLE module;
a flexible microstrip patch antenna-attached to a first side of the BLE module; and
a temperature sensor attached to a second side of the BLE module, which is opposite to the first side,
wherein the temperature sensor-includes a doped VO₂ sensing layer, the temperature sensor being configured to measure a temperature of a person wearing the wearable.

14. The wearable of claim 13, wherein the doped VO₂ sensing layer is doped with W atoms.

15. The wearable of claim 14, wherein the doped VO₂ sensing layer is doped to lower a metal-insulator-transition, MIT, temperature T_{MIT} to about 31° C.

16. The wearable of claim 15, wherein the doped VO₂ sensing layer includes about 1.5% W atoms to achieve the T_{MIT} of about 31° C.

17. The wearable of claim 13, wherein the flexible microstrip patch antenna comprises:
a metallic plane configured to be flexible, the metallic plane including two symmetrical resonating slots; and
a feeding port attached to the metallic plane.

18. The wearable of claim 17, wherein the microstrip patch antenna further comprises:
a U-slot formed in the metallic plane and located around the feeding port.

19. A temperature sensor comprising:
a substrate;
first and second electrodes-located on the substrate; and
a W-doped VO₂ sensing layer located between and in electrical contact with ends of the first and second electrodes,
wherein the temperature sensor is configured to measure a temperature of a person wearing the wearable.

20. The temperature sensor of claim 19, wherein the doped VO₂ sensing layer is doped with about 1.5% W atoms to lower a metal-insulator-transition, MIT, temperature T_{MIT} to about 31° C.
